(19) United States
(12) Patent Application Publication
(10) Pub. No.: US 2008/0245395 A1
(43) Pub. Date: Oct. 9, 2008

(54) Antimicrobial compositions and methods

(76) Inventor: Frank B. Chen, Greensboro, NC (US)

Correspondence Address: WALTER L. BEAVERS, 326 SOUTH EUGENE STREET, GREENSBORO, NC, 27401, US

(21) Appl. No.: 11/784,563

(22) Filed: Apr. 6, 2007

(51) Int. Cl. B08B 7/00; C11D 9/26; C11D 9/28

(52) U.S. Cl. 134/42; 510/383; 510/403; 514/724

(57) ABSTRACT

Antimicrobial compositions and methods eradicate and remove fungi and bacteria from indoor and outdoor structures and materials including porous substrates. The antimicrobial compositions can be made from gel precursors, utilized in gel states and adjusted to reduce the viscosity for applications where low viscosity is advantageous. The antimicrobial compositions applied to a surface can be wiped and rinsed to remove the antimicrobial composition and organic residue.

### FIELD OF THE INVENTION

The invention herein pertains to antimicrobial compositions and particularly pertains to antimicrobial gels for use in eradicating various molds, mildews and bacteria inside homes, buildings, on construction materials and on outside structures.

### DESCRIPTION OF THE PRIOR ART AND OBJECTIVES OF THE INVENTION

Various fungi are common in many warmer areas of the United States and other countries. Many fungi flourish both inside and outside buildings and may occur on floors, ceilings and walls. Moreover, bacteria exists practically everywhere. Killing and removing microbes can be hazardous to building inhabitants and requires extensive, specialized cleaning and labor. It is common practice to clean and remove various microbes by utilizing sodium hypochlorite solutions, alkyl dimethyl benzyl ammonium chloride solutions, alcohol solutions and hydrogen peroxide. These solutions are generally thin, watery mixtures which can be detrimental to plants, soil and water resources when used outdoors and when used indoors, can be hazardous to the health of the inhabitants through contact with the skin, hair or eyes. Also, when removing microbes from inside a building, damage to floors, carpets, furniture, etc. often occurs if extreme precautions are not taken.

U.S. Pat. No. 5,346,641 teaches a thickened aqueous cleaning solution containing sodium hypochlorite, a suspended particulate abrasive and an aluminum oxide thickener. However, upon standing the particulate abrasive will often settle, becoming hard and thus requiring substantial agitation and mixing before use.

U.S. Pat. No. 5,731,276 provides an improved thickened cleaning solution using aluminum oxide without a particulate abrasive to better maintain its flow characteristics. U.S. Pat. No. 5,055,219 teaches a viscoelastic cleaning solution utilizing a quaternary ammonium compound, an organic counterion mixture and a sodium hypochlorite. Another cleaning solution is shown in U.S. Pat. No. 4,900,467.

While these references teach thickened cleaning solutions which may contain sodium hypochlorite or other active ingredients, they do not provide the desired properties for removing microbes on vertical surfaces and ceilings.

Also, prior thickened aqueous solutions used in conjunction with halogen compounds demonstrate reduced viscosity upon aging and lessening of the effectiveness of the halogen compounds due to internal chemical reactions.

Additionally, prior aqueous cleaning or antimicrobial compositions are not suitable for all applications. For example when applying certain of the compositions to a ceiling for antimicrobial purposes, the viscosity is too low to avoid dripping and running.

Thus, with the disadvantages and problems associated with prior art antimicrobial compositions and other cleaning solutions, the present invention was conceived and one of its objectives is to provide antimicrobial gels which allow for easy viscosity adjustment by the user, depending on the particular substrate encountered.

Another objective of the present invention is to provide a gel precursor that is converted to an antimicrobial gel upon addition of the antimicrobial component.

It is another objective of the present invention to provide antimicrobial gels which possess the often needed effectiveness and desired non-dripping, non-splashing characteristics.

It is still another objective of the present invention to provide antimicrobial gels which can be safely adjusted to proper viscosity by relatively unskilled personnel for use on ceilings, walls, floors or porous surfaces as needed.

It is a further objective of the present invention to provide microbial removal processes which cause minimal environmental damage when used outdoors.

It is yet a further objective of the present invention to provide antimicrobial gels which may include various disinfectants.

Other objectives and advantages of the present invention will become apparent to those skilled in the art as a more detailed description is set forth below.

### SUMMARY OF THE INVENTION

The aforesaid and other objectives are realized by providing antimicrobial compositions, specifically antimicrobial gels whereby the viscosity can be easily adjusted prior to application to a particular substrate. For example, an antimicrobial gel can be prepared by adding a six percent (6%) by weight sodium hypochlorite solution at a ratio of one (1) part sodium hypochlorite solution to three (3) parts of gel, resulting in an effective antimicrobial gel of 1.5% by weight sodium hypochlorite. This antimicrobial gel can be applied to a room ceiling without dripping or splashing occurring. The same antimicrobial gel without viscosity adjustment can be used to treat mold, mildew or bacteria infested vertical surfaces such as walls. To use the gel for a porous floor substrate such as a cement patio or walkway, the gel can be diluted by adding water in the ratio of four (4) parts of antimicrobial gel to one-two (1-2) parts of water for sufficient penetration and microbe eradication.

Other suitable materials for application include construction materials such as lumber, wood panels, cement blocks, stone, stone blocks, stone veneer and bricks.

After the microbes are treated, an abrasive pad or sandpaper can be used to scour the treated surface. Thereafter the surface can be cleaned with a mop or wiped, and the surface thereafter thoroughly rinsed with water. Wood or painted surfaces may require an additional application of conventional paint, stain or varnish as suited.

### DETAILED DESCRIPTION OF THE PREFERRED EMBODIMENTS AND OPERATION OF THE INVENTION

Specifications, characteristics and sources of various conventional ingredients used in examples herein are described below:
Deionized Water from any commercial supplier is suitable;
Ethyl Alcohol (95% in water by volume) from any commercial supplier is suitable;
Sodium Silicate solid from any commercial supplier is suitable;
Potassium Hydroxide (45% in water by weight) from Alfa Chemicals of Kings Point, N.Y.;
Alkyl Dimethyl Benzyl Ammonium Chloride (with alkyl group defined as 67% C12, 25% C14, 7% C16 and 1% C8, C10 and C18 combined) as liquid from Alfa Chemicals of Kings Point, N.Y.;
Alkyl Dimethyl Benzvl Ammonium Chloride (with alkyl group defined as 50% C14, 40% C12 and 10% C16) as liquid from Alfa Chemicals of Kings Point, N.Y.;
Propyl Alcohol (100% strength) from Alfa Chemicals of Kings Point, N.Y.;
2% Methocel 240S (cellulosic polymer) as standard liquid from Dow Chemical of Midland, Mich.;
Propylene Glycol as liquid from Dow Chemical of Midland, Mich.;
Aluminum Oxide as standard 1,000 grit solid from Electro Abrasives Corp. of Buffalo, N.Y.;
Mica as solid from Englehard Corp. of Iselin, N.J.;
Sodium Hydroxide (10% in water by weight) from FMC Corp. of Philadelphia, Pa.;
Sodium Hydroxide (50% in water by weight) from FMC Corp. of Philadelphia, Pa.;
Sodium Tripolyphosphate (cleaning agent) as solid from FMC Corp. of Philadelphia, Pa.;
Carbopol EZ-2 (polyamide polymer) as standard solid from Noveon, Inc. of Cleveland, Ohio;
Carbopol 676 (polyamide polymer) as standard solid from Noveon, Inc. of Cleveland, Ohio;
Sodium Hypochlorite (6% in water by weight) from Olin Corp. Of Norwalk, Conn.;
Hydrogen Peroxide (10% in water by weight) from Olin Corp. Of Norwalk, Conn.;
Oxy-Rite 100 as standard liquid from Noveon, Inc. of Cleveland, Ohio;
Tamol 731A (dispersant) as standard liquid from Rohm & Haas of Philadelphia, Pa.;
Acrysol ASE 60 (poly-acrylic polymer/latex) as standard liquid from Rohm & Haas of Philadelphia, Pa.;
Laponite (clay/modified clay) as solid from Southern Clay Products, Inc. of Austin, Tex;
Calcium Carbonate as solid from Spectrum Chemical MFG of Gardena, Calif.;
Potassium Silicate (39% in water by weight) from The PQ Corp. of Valley Forge, Pa.; and
Trovsan Polyphase P-20T (antimicrobial) as standard liquid from Troy Corp. of Florham, N.J.

For clarity, the following nomenclature applies: “Antimicrobial gel” and “antimicrobial composition” shall refer to the combination of the gel component and antimicrobial component. “Gel”, as used herein, refers to the gel component of the antimicrobial gel, without the antimicrobial component. “Antimicrobial” or “antimicrobial component” pertains generically to the antifungal or bactericidal components of sodium hypochlorite, alkyl dimethyl benzyl ammonium chloride, propyl alcohol, ethyl alcohol or hydrogen peroxide, without the gel component. Alternatively, “antimicrobial” generically describes a substance's bacteriostatic, bactericidal, fungistatic or fungicidal property. “Microbes” include fungi and bacteria.

For a better understanding of the invention, the antimicrobial gels are prepared in the following examples to provide the desired viscosity for cleaning a particular substrate. Example 7 discloses a gel precursor which is mixed with the antimicrobial component to form an antimicrobial gel. The preferred form of the invention is set forth in Example 1 below:

### EXAMPLE 1

### Part I: (Gel Component)

In a suitable container under constant mixing the following ingredients are added sequentially to prepare the gel component:

| Ingredient | Wt % |
|---|---|
| Deionized Water | 94.90 |
| Tamol 731A | 0.10 |
| Carbopol EZ-2 | 2.00 |
| Sodium Hydroxide (10%) | 3.00 |
| | 100.00 |

### Part II: (Antimicrobial Component)

| Ingredient | Wt % |
|---|---|
| 6% sodium hypochlorite solution | 100.00 |

The antimicrobial gel is formed by blending three (3) parts of the gel component with one (1) part of the antimicrobial component, by weight. The resulting 1.5% by weight sodium hypochlorite antimicrobial gel is gently agitated to achieve a homogeneous antimicrobial gel.

### EXAMPLE 2

### Part I: (Gel Component)

The gel component is prepared under constant mixing by adding the following ingredients sequentially:

| Ingredient | Wt % |
|---|---|
| Deionized Water | 92.98 |
| Acrysol ASE 60 | 4.00 |
| Sodium Hydroxide (10%) | 3.00 |
| Troysan Polyphase P-20T | 0.02 |
| | 100.00 |

### Part II: (Antimicrobial Component)

| Ingredient | Wt % |
|---|---|
| 6% sodium hypochlorite solution | 100.00 |

The antimicrobial gel is formed by blending three (3) parts of the gel component with one (1) part of the antimicrobial component, by weight. The resulting 1.5% by weight sodium hypochlorite antimicrobial-gel is gently agitated to achieve a homogeneous antimicrobial gel.

### EXAMPLE 3

### Part I: (Gel Component)

The gel component is prepared under constant mixing by adding the following ingredients sequentially:

| Ingredient | Wt % |
|---|---|
| Deionized Water | 44.72 |
| Tamol 731A | 0.10 |
| Carbopol 676 | 2.00 |
| Oxy-Rite 100 | 0.11 |
| Potassium Carbonate | 5.43 |
| 2.1r Potassium silicate (39%) | 15.14 |
| Potassium Hydroxide (45%) | 5.43 |
| Sodium Hydroxide (50%) | 5.43 |
| Sodium tripolyphosphate | 21.64 |
| | 100.00 |

### Part II: (Antimicrobial Component)

| Ingredient | Wt % |
|---|---|
| 6% sodium hypochlorite solution | 100.00 |

The antimicrobial gel is formed by blending three (3) parts of the gel component with one (1) part of the antimicrobial component, by weight. The resulting 1.5% by weight sodium hypochlorite antimicrobial gel is gently agitated to achieve a homogeneous antimicrobial gel.

### EXAMPLE 4

### Part I: (Gel Component)

The gel component is prepared under constant mixing by adding the following ingredients:

| Ingredient | Wt % |
|---|---|
| Laponite | 2.00 |
| Deionized Water | 98.00 |
| | 100.00 |

### Part II: (Antimicrobial Component)

| Ingredient | Wt % |
|---|---|
| 6% sodium hypochlorite solution | 100.00 |

The antimicrobial gel is formed by blending three (3) parts of the gel component with one (1) part of the antimicrobial component, by weight. The resulting 1.5% by weight sodium hypochlorite antimicrobial gel is gently agitated to achieve a homogeneous antimicrobial gel.

### EXAMPLE 5

### Part I: (Gel Component)

The gel component is prepared under constant mixing by adding the following ingredients sequentially:

| Ingredient | Wt % |
|---|---|
| Deionized Water | 19.72 |
| Tamol 731A | 0.10 |
| 2% Methocel 240S | 20.00 |
| Modified Clay | 2.00 |
| Mica | 10.00 |
| Calcium carbonate | 48.18 |
| | 100.00 |

### Part II: (Antimicrobial Component)

| Ingredient | Wt % |
|---|---|
| 6% sodium hypochlorite solution | 100.00 |

The antimicrobial gel is formed by blending three (3) parts of the gel component with one (1) part of the antimicrobial component, by weight. The resulting 1.5% by weight sodium hypochlorite antimicrobial gel is gently agitated to achieve a homogeneous antimicrobial gel.

### EXAMPLE 6

### Part I: (Gel Component)

The gel component is prepared under constant mixing by adding the following ingredients sequentially:

| Ingredient | Wt % |
|---|---|
| Deionized Water | 88.90 |
| Tamol 731A | 0.10 |
| Acrysol ASE 60 | 2.00 |
| Aluminum Oxide (1,000 grit) | 5.00 |
| Sodium Hydroxide (10%) | 4.00 |
| | 100.00 |

### Part II: (Antimicrobial Component)

| Ingredient | Wt % |
|---|---|
| 6% sodium hypochlorite solution | 100.00 |

The antimicrobial gel is formed by blending three (3) parts of the gel component with one (1) part of the antimicrobial component, by weight. The resulting 1.5% by weight sodium hypochlorite antimicrobial gel is gently agitated to achieve a homogeneous antimicrobial gel.

### EXAMPLE 7

### Part I: (Gel Precursor Component)

The gel precursor component is prepared under constant mixing by adding the following ingredients sequentially:

| Ingredient | Wt % |
|---|---|
| Deionized Water | 85.60 |
| Tamol 731A | 0.13 |
| Aluminum Oxide (1,000 grit) | 4.75 |
| Acrysol ASE 60 | 9.52 |
| | 100.00 |

### Part II: (Antimicrobial Component)

| Ingredient | Wt % |
|---|---|
| 6% sodium hypochlorite solution | 100.00 |

The antimicrobial gel is formed by blending three (3) parts of the gel precursor component with one (1) part of the antimicrobial component, by weight. The resulting 1.5% by weight sodium hypochlorite antimicrobial mixture thickens into an antimicrobial gel upon gentle agitation due to the pH of the antimicrobial component.

### EXAMPLE 8

### Part I: (Gel Component)

The gel component is prepared under constant mixing by adding the following ingredients sequentially:

| Ingredient | Wt % |
|---|---|
| Deionized Water | 94.90 |
| Tamol 731A | 0.10 |
| Carbopol EZ-2 | 2.00 |
| Sodium hydroxide (10%) | 3.00 |
| | 100.00 |

### Part II: (Antimicrobial Component)

| Ingredient | Wt % |
|---|---|
| 6% sodium hypochlorite solution | 100.00 |

The antimicrobial gel is formed by blending three (3) parts of the gel component with one (1) part of the antimicrobial component, by weight. The resulting 1.5% by weight sodium hypochlorite antimicrobial gel is gently agitated to achieve a homogeneous antimicrobial gel.

### EXAMPLE 9

### Part I: (Gel Component)

The gel component is prepared under constant mixing by adding the following ingredients sequentially:

| Ingredient | Wt % |
|---|---|
| Deionized Water | 94.90 |
| Tamol 731A | 0.10 |
| Carbopol EZ-2 | 2.00 |
| Sodium hydroxide (10%) | 3.00 |
| | 100.00 |

### Part II: (Bactericidal Component)

| Ingredient | Wt % |
|---|---|
| Propylene Glycol | 1.00 |
| alkyl (67% C12, 25% C14, 7% | 0.32 |
| C16, 1% C8–C10–C18) dimethyl | |
| benzyl ammonium chloride | |
| alkyl (50% C14, 40% C12, | 0.08 |
| 10% C16) dimethyl benzyl | |
| ammonium chloride | |
| water | 98.60 |
| | 100.00 |

The antimicrobial gel is formed by blending three (3) parts of the gel component with one (1) part of the bactericidal component, by weight. The mixture is gently agitated to achieve a homogeneous antimicrobial gel.

### EXAMPLE 10

### Part I: (Gel Component)

The gel component is prepared under constant mixing by adding the following ingredients sequentially:

| Ingredient | Wt % |
|---|---|
| Deionized Water | 94.90 |
| Tamol 731A | 0.10 |
| Carbopol EZ-2 | 2.00 |
| Sodium hydroxide (10%) | 3.00 |
| | 100.00 |

### Part II: (Bactericidal Component)

| Ingredient | Wt % |
|---|---|
| 95% Ethyl Alcohol | 100.00 |

The antimicrobial gel is formed by blending three (3) parts of the gel component with one (1) part of the bactericidal component, by weight. The mixture is gently agitated to achieve a homogeneous antimicrobial gel.

The antimicrobial gels above are preferably diluted with water at a ratio of four (4) parts of gel to one-to-two (1-2) parts of water to thin or lower the viscosity of the antimicrobial gel for use in treating porous floor substrates such as a cement patios, walkways or driveways. More water can be added to provide a less viscous antimicrobial gel.

Although Examples 1-8 employ the preferred 6% by weight sodium hypochlorite solution, other strengths could be used to form antimicrobial compositions which range from 0.05% to 6.0% by weight sodium hypochlorite. It should also be understood that the sodium hypochlorite could be an alkali metal compound, alkali earth metal compound or a combination thereof. However, as shown in Examples 9 and 10 respectively, alkyl dimethyl benzyl ammonium chloride (with alkyl groups of 67% C12, 25% C14, 7% C16, 1% C8-C10-C18 and 50% C14, 40% C12, 10% C16) or ethyl alcohol, (preferably 95%) may provide the antimicrobial (bactericidal) properties, instead of sodium hypochlorite. Moreover, propyl alcohol or hydrogen peroxide, respectively at approximately 30% and 10% by weight of antimicrobial composition, may also provide the antimicrobial component of the antimicrobial composition.

Suitable “thickeners” include cellulosic polymers, poly-acrylic polymers or copolymers, polyamide polymers or copolymers, alkali swellable latexes, high temperature alkali swellable latexes, clay or modified clay, natural gums, sodium silicate or any combination thereof. The thickened gel may also contain other desirable functional additives such as dispersants, agents which prolong the activity of the antimicrobial component, cleaners, pH adjusting agents, electrolytes, buffers, fragrance, abrasives, de-foaming agents, anti-foaming agents or any mixtures thereof. These functional additives should be stable in sodium hypochlorite, alkyl dimethyl benzyl ammonium chloride, propyl alcohol, ethyl alcohol or hydrogen peroxide depending on the antimicrobial utilized.

While various examples of are shown to form two-component antimicrobial compositions, in Example 7 a gel precursor component and a caustic antimicrobial component (sodium hypochlorite) are combined to form the antimicrobial composition. Alternatively, a three-component composition could be formed by combining a gel precursor (such as in Example 7), an antimicrobial component (such as dimethyl benzyl ammonium chloride, propyl alcohol, ethyl alcohol or hydrogen peroxide) and a caustic (such as sodium hydroxide). The antimicrobial composition, whether formed from a gel precursor, can be used at a job site such as a house with mildew and mold both on the interior and on out of door locations. For ceiling and wall applications the antimicrobial gel has sufficient viscosity for direct application using a putty knife or other tool. Other methods of application include brushes, rollers, pads or air-assisted airless guns. Once applied, the eradication of the mold and mildew can be observed after a few minutes. Alternatively the antimicrobial gel treatment is considered finished when the antimicrobial component diminishes effectiveness. Next, the residue can be wiped off with a cloth. Thereafter a water rinse is applied, such as by using a wet cloth. Once the surface dries the treated area can be refinished with paint or other coatings as desired.

The same antimicrobial gels can likewise by used for floors, shelves or the like, but the viscosity is preferably reduced for ease in application and greater penetration. To reduce the viscosity, 3 parts of the antimicrobial gel are blended with 1-2 parts of water.

The antimicrobial gels may also be applied to construction materials such as lumber, wood panels, cement blocks, stone, stone blocks, stone veneer and bricks. Those treated construction materials may then be stored for later use.

The illustrations and examples provided herein are for explanatory purposes and are not intended to limit the scope of the appended claims.

1. A two-part antimicrobial composition comprising: a first part comprising a gel precursor and a second part comprising a water-soluble hypochlorite with metal counter ion whereby said water-soluble hypochlorite with metal counter ion is blended with said gel precursor upon selecting a surface for microbial eradication to form a hypochlorite gel.

2. The composition of claim 1 wherein said gel precursor comprises an alkali swellable latex, alkali soluble latex, alkali thicken-able polymer, or combination thereof.

3. A two part antimicrobial composition comprising: a first part comprising a gel and a second part comprising a non-bleach based antimicrobial.

4. The composition of claim 3 wherein said gel part further comprises a thickener, said thickener comprising cellulosic polymers, polyacrylic polymers, polyamide polymers, latexes, clay, modified clay, sodium silicate or any combination thereof.

5. The composition of claim 1 wherein said water-soluble hypochlorite with metal counter ion is selected from the group comprising alkali metal compounds and alkali earth metal compounds.

6. (canceled)

7. The composition of claim 3 wherein said antimicrobial composition further comprises alkyl dimethyl benzyl, ammonium chloride, propyl alcohol, ethyl alcohol or hydrogen peroxide.

8. A method of removing microbes comprising the steps of:
a) selecting a first microbe laden surface and thereafter;
b) preparing an antimicrobial gel composition as described in claim 1 or claim 3;
c) adjusting the viscosity of the antimicrobial gel composition according to characteristics of the first microbe laden surface; and
d) applying the antimicrobial composition to the first microbe laden surface to eradicate the microbes therefrom.

9. The method of claim 8 wherein blending an antimicrobial gel composition further comprises the step of utilizing an antimicrobial comprising water-soluble hypochlorite with metal counter ion, alkyl dimethyl benzyl ammonium chloride, propyl alcohol, ethyl alcohol or hydrogen peroxide.

10. The method of claim 8 further comprising the step of removing the antimicrobial composition after the eradication of microbes.

11. The method of claim 8 wherein adjusting the viscosity comprises the step of diluting the antimicrobial gel composition to reduce the viscosity thereof.

12. The method of claim 8 wherein blending an antimicrobial gel composition further comprises the step of forming a gel precursor and a bleach based antimicrobial or a gel and a non-bleach based antimicrobial.

13. A method of treating construction materials to retard fungus growth comprising the steps of:
a) selecting the particular construction materials to be treated and thereafter;
b) preparing an antimicrobial gel as described in claim 1 or claim 3;
c) adjusting the viscosity of the antimicrobial gel for the particular materials; and
d) applying the antimicrobial gel to the selected construction materials to eradicate and retard fungus growth.

14. The method of claim 13 wherein forming an antimicrobial gel further comprises the step of utilizing an antimicrobial comprising a water-soluble hypochlorite with metal counter ion, alkyl dimethyl benzyl ammonium chloride, propyl alcohol, ethyl alcohol or hydrogen peroxide.

15. The method of claim 13 wherein forming an antimicrobial gel further comprises the step of diluting the antimicrobial gel to reduce the viscosity.

16. The method of claim 13 further comprising the step of storing the construction materials with the antimicrobial gel thereon.

17. (canceled)

18. The method of claim 13 further comprising the step of applying the antimicrobial gel to construction materials comprising lumber, wood panels, cement blocks, stone, stone blocks, stone veneer and bricks.

19. A three-part antimicrobial gel comprising a first part comprising a gel precursor, a second part comprising a bleach based antimicrobial and a third part comprising a caustic chemical, whereby adding the second part and the third part to the first part will form a non-dripping antimicrobial gel upon mild agitation.

20. The method of claim 8 further comprising the steps of:
a) selecting a second microbe laden surface different in character from the first microbe laden surface and thereafter;
b) adjusting the viscosity of the antimicrobial gel composition according to characteristics of the second microbe laden surface; and
c) applying the antimicrobial gel composition to the second microbe laden surface to eradicate the microbes therefrom.

21. The composition of claim 2 further comprising a wetting agent, a defoamer, a preservative or an abrasive, or any combination thereof.

22. The composition of claim 4 further comprising a wetting agent, a defoamer, a preservative or an abrasive, or any combination thereof.

23. The method of claim 8 wherein blending an antimicrobial gel composition further comprises the step of forming a gel precursor and a non-bleach based antimicrobial.

24. The method of claim 13 wherein preparing an antimicrobial gel comprises the step of forming a bleach based gel precursor.

25. A three part antimicrobial gel comprising a first part comprising a gel precursor, a second part comprising a non-bleach based antimicrobial and a third part comprising a caustic chemical, whereby adding the second part and the third part to the first part will form a non-dripping antimicrobial gel upon mild agitation.
